(19) United States
(12) Patent Application Publication
(10) Pub. No.: US 2022/0401977 A1
(43) Pub. Date: Dec. 22, 2022

(54) Temperature Controlled Surface Coating Application System

(71) Applicant: Gary HAVERDA, San Antonio, TX (US)

(72) Inventor: Gary HAVERDA, San Antonio, TX (US)

(21) Appl. No.: 17/831,403

(22) Filed: Jun. 2, 2022

Related U.S. Application Data
(60) Provisional application No. 63/196,218, filed on Jun. 2, 2021.

(51) Int. Cl. B05B 7/16; B05B 12/10

(52) U.S. Cl. CPC B05B 7/1606; B05B 12/10

(57) ABSTRACT

Systems and methods for controlling the temperature of liquid coatings discharged from air pressurized spray pots and the like are described. The non-electrical temperature-controlled systems rely on the pressurization and expansion of air and/or other gases to lower or increase the temperature of the sprayed liquid coating. The system includes cooling coils surrounding a pressurized spray pot contained within an insulated enclosure. Pressurized ambient air is passed through a cooling vortex cylinder before passing into the cooling coils. The cooled air preferably then passes into an insulated envelope surrounding the discharge lines to the spray gun. An optional system structure adds a second cooling vortex cylinder to reduce the temperature of the pressurized air in a second flow line that serves to pressurize the spray pot and to pass to the spray gun parallel to the cooled liquid line.

### CROSS REFERENCES TO RELATED APPLICATIONS

This application claims the benefit under Title 35 United States Code §119(e) of U.S. Provisional Patent Application Ser. No. 63/196,218; Filed: Jun. 2, 2021; the full disclosure of which is incorporated herein by reference.

### BACKGROUND OF THE INVENTION

### 1. Field of the Invention

The present invention relates generally to systems and methods for applying coatings to surfaces. The present invention relates more specifically to systems and methods for controlling the temperature of liquid coatings discharged from air pressurized spray pots and the like. The present invention relates most specifically to non-electrical temperature-controlled systems that rely on the pressurization and expansion of air and/or other gases to lower or increase the temperature of the sprayed liquid coating.

### 2. Description of the Related Art

In recent years, the field of industrial coatings has undergone many changes. While improved formulations for liquid coatings have resulted in better surface adherence and durability, they have unfortunately also resulted in liquid coatings are increasingly temperature sensitive. In other words, the temperature ranges for application have narrowed to the point that ambient conditions have a significant affect on the quality of the coating once applied.

As an example, the temperature range for application of a coating might have a low of 45° F. and a high (the temperature where the coating starts setting up or curing very fast) of 75° F. It is this higher end that creates typical coating application concerns. Once the coating material starts setting up, often within twenty-five minutes or less when the ambient air is above 90° F., it creates issues for spraying out two gallons of material (for example) which might normally require forty-five minutes to an hour to spray out.

With the above in mind, the present invention describes what is essentially a paint pot cooler along with the associated pressurized air hoses and fluid coating flow lines for spray application of the coating. The system includes an insulated enclosure sized to allow a paint pot or a five-gallon bucket to be enclosed. The vault has air driven cool air blown into it that works to keep the ambient temperature surrounding material in the paint pot or can at a much cooler level. The idea is that this would allow longer spray out times of heat sensitive material. The system could also be structured to warm up to 20° F. above ambient. Potentially even warmer air could be achieved. Along with the cooler, the paint lines and air lines leading out to spray gun would also be insulated and preferably cooled.

The system of the present invention is simple enough as to not require electricity, at least at the pressure pot and spray nozzle. A remotely positioned electric or gas-powered pneumatic compressor may preferably be employed. The purpose of this system structure is to keep extra equipment and potential sparks away from flammable material. The air changers used in the system of the present invention are available and are driven by compressed air already required and available for the abrasive blasting and spray coating process.

### SUMMARY OF THE INVENTION

The present invention provides systems and methods for controlling the temperature of liquid coatings discharged from air pressurized spray pots and the like. The non-electrical temperature-controlled systems rely on the pressurization and expansion of air and/or other gases to lower or increase the temperature of the sprayed liquid coating. The system includes cooling coils surrounding a pressurized spray pot with both contained within an insulated enclosure. Pressurized ambient air is passed through a cooling vortex cylinder before passing the cooled air into the cooling coils. The cooled air preferably then passes into an insulated envelope surrounding the discharge lines on their way to the spray gun. An optional system structure adds a second cooling vortex cylinder to reduce the temperature of the air in the second pressurized air line that pressurizes the spray pot and passes through to the spray gun parallel to the cooled liquid line.

### BRIEF DESCRIPTION OF THE DRAWINGS

FIG. 1 is a schematic block diagram of a first preferred embodiment of the present invention with a single cooling vortex cylinder producing a cooled pressurized spray pot and a cooled liquid spray line to the spray gun.

FIG. 2 is a is a schematic block diagram of a second preferred embodiment of the present invention with a two separate cooling vortex cylinders producing a cooled pressurized spray pot and a cooled liquid spray line to the spray gun, as well as a separate cooled air line pressurizing the spray pot and passing directly to the spray gun parallel to the cooled liquid line.

FIG. 3 is an exploded perspective view of the primary components of the second preferred embodiment of the present invention.

### DETAILED DESCRIPTION OF THE PREFERRED EMBODIMENTS

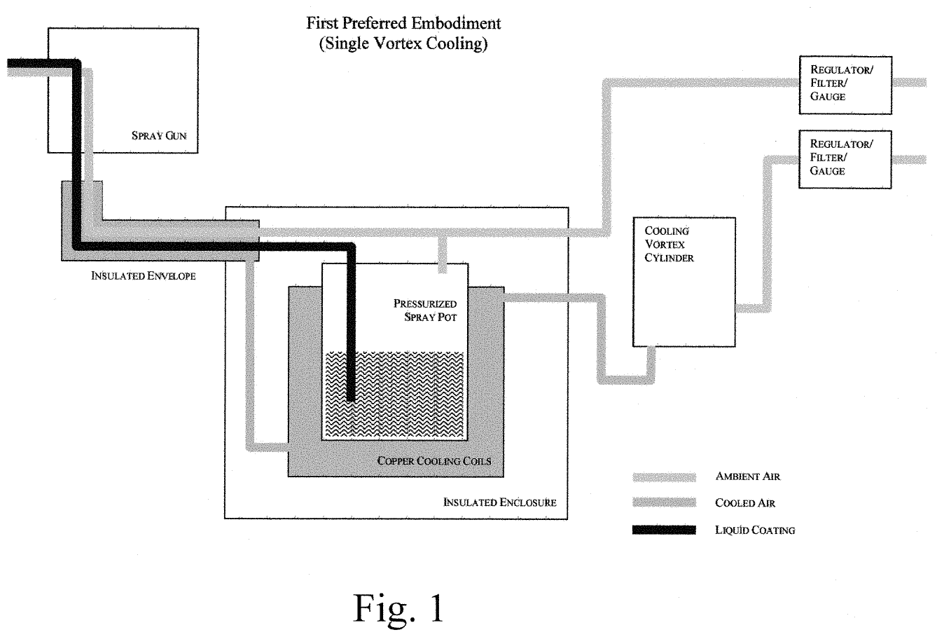

Reference is made first to FIG. 1 which provides a diagram of a first preferred embodiment of the present invention. In this first embodiment, a single cooling vortex cylinder produces a flow of cooled air to copper cooling coils (or the like) to reduce the temperature of the pressurized spray pot.

After passing through the cooling coils the cooled air passes through an exit manifold into an insulated envelope surrounding the liquid line to the spray gun. The liquid coating material flowing from the pressurized spray pot is maintained at the lower temperature up to the point of being dispensed (with a parallel flow of pressurized air) through the spray gun.

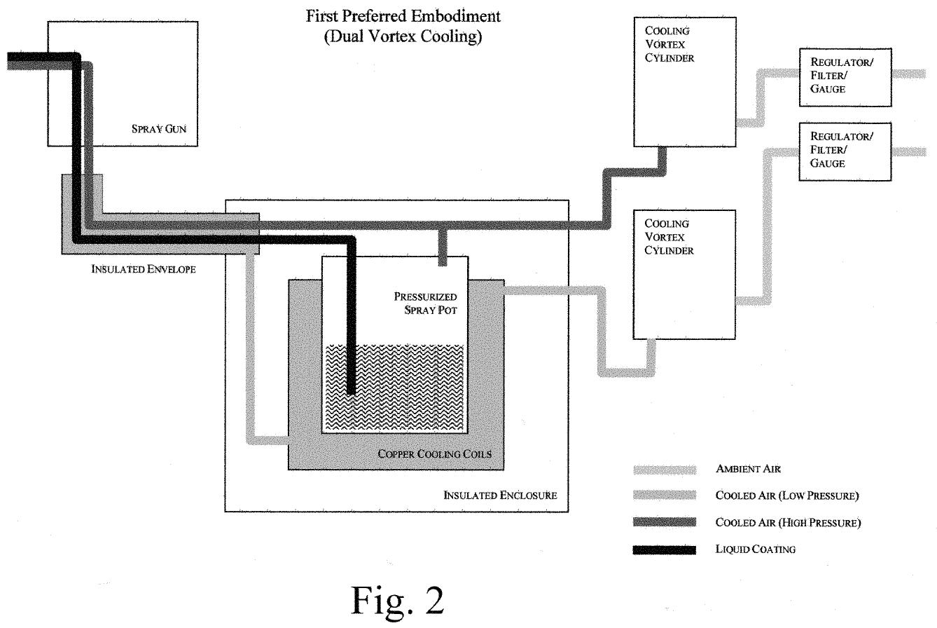

FIG. 2 is a diagram of a second preferred embodiment of the present invention. In this alternate embodiment, a first cooling vortex cylinder produces a flow of cooled air to copper cooling coils (or the like) to reduce the temperature of the pressurized spray pot as in the first preferred embodiment. Once again, after passing through the cooling coils the cooled air passes through an exit manifold into an insulated envelope surrounding the liquid line to the spray gun. The liquid coating material flowing from the pressurized spray pot is maintained at the lower temperature up to the point of being dispensed (with a parallel flow of pressurized air) through the spray gun.

In this alternate embodiment shown in FIG. 2, a second cooling vortex cylinder is positioned in the flow line of pressurized ambient air that pressurizes the spray pot and flows in parallel with the fluid line to the spray gun. As a result, not only is the liquid maintained at a lower temperature, the pressurized air flow that facilitates the spraying process at the spray gun is also maintained at a lower temperature. With some fluid coatings this additional cooling of the air flow, in addition to the cooling of the fluid flow, could be significant in extending the curing time for the coating.

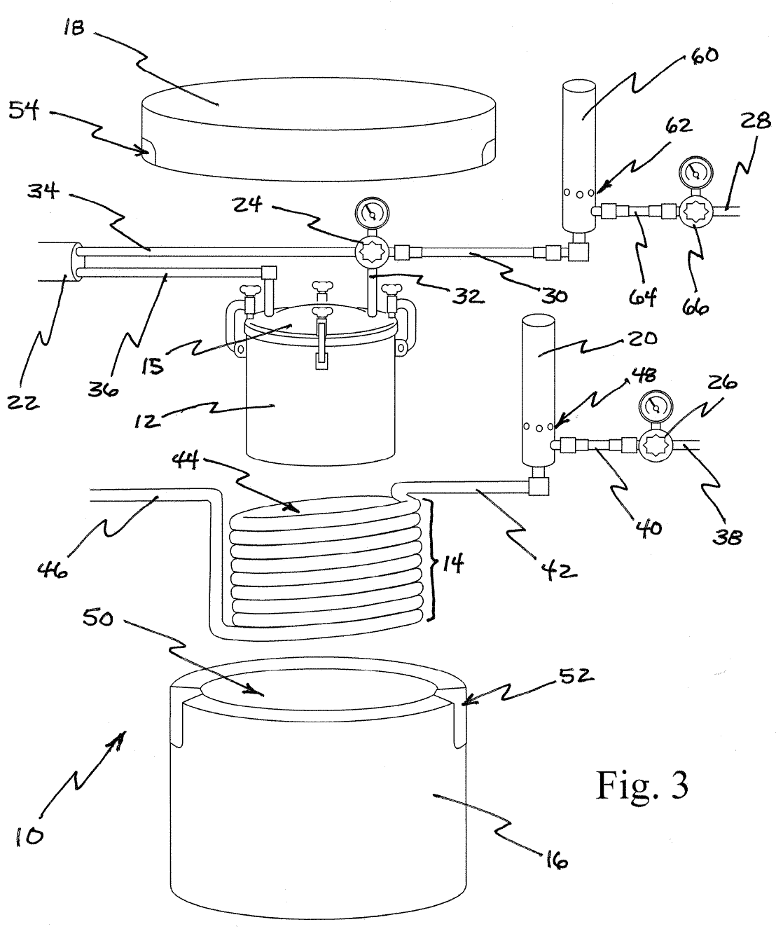

Reference is next made to FIG. 3 which is an exploded perspective view of the primary components of the second preferred embodiment of the present invention. The first preferred embodiment simply leaves out some of the components of the system as shown in the differences between FIGS. 1 & 2. In FIG. 3, the surface coating application system 10 is shown to be an assembly of existing, modified, and new components. The components shown in FIG. 3 may be configured separately as shown and described or may be integrated together in groups to form unitary components. It may be preferable, for example, for the standard pressure pot base to have the insulation and the coiled conduit manufactured into the walls of the cylindrical container rather than be assembled as shown in FIG. 3. Likewise, the pressure pot lid may be manufactured with the insulation and the through ports incorporated rather than assembled as shown in FIG. 3. Such various ways of combining these essential elements of the system all adhere to the basic functional requirements of the components.

In FIG. 3, the primary components of application system 10 are shown to be generally constructed from pressurized spray pot 12, cylindrical copper cooling coils 14, pressurized spray pot lid 15, insulated enclosure base 16, and insulated enclosure lid 18. Cooling vortex cylinders 20 & 60 are connected to the inflow of ambient air into the system 10 in the manner described below. Insulated hose envelope 22 encloses spraying air outlet line 34 and liquid coating outlet line 36.

Cooling coils 14 surround and are in thermal contact with the metal (typically) walls if pressurized spray pot 12 and are in turn surrounded by insulated enclosure base 16. The central opening 44 created by cooling coils 14 is sized to fit tightly around pressure pot 12 and to thereby maintain good thermal contact with the walls of the pressurized enclosure. Cooling coils 14 are preferably made up of a continuous conduit and have an inlet line 42 and an outlet line 46.

The central opening 50 of insulated enclosure base 16 is sized to fit snugly around cooling coils 14. Apertures or slots 52 in insulated enclosure base 16 are positioned to accommodate inlet line 42 and outlet line 46 when the components are assembled. Pressurized spray pot lid 15 is, as is typical in the art, configured to seal pressure pot 12 after the liquid coating material is positioned inside. At least two ports penetrate spray pot lid 15, a pressurized air inlet line 32 and the liquid coating outlet line 36. Other ports as may be connected to ancillary lines and other gauges may be positioned through the spray pot lid.

In the embodiment shown in FIG. 3, there are two compressed air inlet lines 28 and 38. Inlet line 38 connects, by way of regulator/filter/gauge 26, to cooling air inlet line 40 which, in the preferred embodiment, includes quick disconnect couplings on each end. Cooling air inlet line 40 carries compressed air into cooling vortex cylinder 20. Heat is absorbed from the compressed air by the action of air flow through the vortex cylinder and is removed (ducted away) through vortex cylinder hot air vents 48. Cooled compressed air (which has dropped slightly in pressure) passes from vortex cylinder 20 through cooling coil connecting line 42.

Inlet line 28 connects, by way of regulator/filter/gauge 66, to spraying compressed air inlet line 64, which in the preferred embodiment includes quick disconnect couplings on each end. Spraying air inlet line 64 carries compressed air into cooling vortex cylinder 60. Heat is absorbed from the compressed air by the action of air flow through the vortex cylinder and is removed through vortex cylinder hot air vents 62. Cooled compressed air (which has dropped slightly in pressure) passes from vortex cylinder 60 through spraying air inlet line 30.

In the above-described manner, both the compressed airflow that serves to carry the liquid coating material from the spray pot and the compressed airflow through the coils are cooled sufficiently to reduce the temperature of the effluent mixture that is sprayed from the system as a coating. The cooled compressed spray airflow through spraying air inlet line 30 flows (past gauge 24) both into the pressure pot 12 to force the liquid coating under pressure out through liquid coating outlet line 36, and direct through spraying air outlet line 34 where the flow streams are eventually mixed at the spray nozzle (not shown in FIG. 3). The cooled compressed cooling airflow through cooling coil connecting line 42 flows through cooling coils 14 where it absorbs heat from the paint pot 12 and then passes on through cooling coil outlet line 46. In the preferred embodiment, cooling coil outlet line 46 flows into insulated hose envelope 22 where it serves to maintain a reduced temperature in spraying air outlet line 34 and liquid coating outlet line 36.

As mentioned above, insulated enclosure lid 18 may be a separate component or an element integrated into the construction of pressure pot lid 15. If a separate component, insulated enclosure lid 18 preferably includes apertures or slots 54 to accommodate spraying air inlet line 30, gauge 24, spraying air outlet line 34, and liquid coating outlet line 36. The various flow lines described above may preferably be steel (such as with spray pot connecting line 32) or may be rubber compressed air hose lines as would typically be used in the various connections that require rigidity or flexibility, as the case may be. Other placements of gauges, filters, and regulators are also anticipated according to the requirements of specific coatings and specific operating environments.

Those skilled in the art will recognize that although the preferred embodiments of the present invention described are generally presented with the basic components associated with the cooling process, various additional valves and internal flow nozzles may be used to increase or decrease the pressure of the air in the pneumatic lines so as to control the cooling (or in some cases the warming) of the system. Likewise, those skilled in the art will recognize various structures and insulative materials that surround the pressure pot and the air and fluid flow lines. Connectors, seals, and valves may preferably be structured to allow for normal access to the pressure pot for the purpose of filling or re-filling the system with the coating material being used. Various types of vortex cooling cylinders are available on the market that will meet the requirements of the system of the present invention. Appropriate flow regulators and filters are positioned as shown in each diagram to increase or decrease the pressure in the input air flow lines as required by the system. Because the vortex cooling cylinders generally operate by allowing a flow of pressurized air to expand (thereby reducing the pressure) the initial pressures into the system will be higher to accommodate the drop and maintain the same output pressures required at the spray gun.

While the various embodiments of the present invention have been described in connection with a number of generalized components, those skilled in the art will anticipate specific components with specific operational ranges to optimize the functionality of the system for various types of coatings and fluids. Systems with such selected characteristics still fall within the spirit and scope of the present invention.

I claim:

1. A system for producing a temperature regulated fluid stream of surface coating material entrained in pressurized air onto a surface to be coated, the system comprising:
a pressurized air source;
a pressurized container for holding a quantity of liquid surface coating material, the pressurized container having a container wall, an inlet, and an outlet, the inlet in flow communication with the pressurized air source;
at least one air flow coil in thermal contact with the container wall of the pressurized container, the at least one air flow coil having an inlet and an outlet;
at least one cooling vortex cylinder having an inlet and an outlet, the inlet in flow communication with the pressurized air source, and the outlet in flow communication with the inlet of the at least one air flow coil; and
a coating application spray device having an air inlet port, a fluid inlet port, and a discharge nozzle, the air inlet port in flow communication with the pressurized air source, the fluid inlet port in flow communication with the pressurized container outlet, the coating application spray device entraining a flow of fluid into a flow of presurrized air to be discharged from the discharge nozzle;
wherein a flow of pressurized air through the at least one cooling vortex cylinder reduces the temperature of the air flow through the at least one air flow coil, thereby reducing the temperature of the container wall of the pressurized container, thereby reducing the temperature of a quantity of liquid surface coating material contained within the pressurized container.

2. A system for producing a temperature regulated fluid stream of surface coating material entrained in pressurized air onto a surface to be coated, the system comprising:
a pressurized air source;
a pressurized container for holding a quantity of liquid surface coating material, the pressurized container having a container wall, an inlet, and an outlet;
at least one air flow coil in thermal contact with the container wall of the pressurized container, the at least one air flow coil having an inlet and an outlet;
a first cooling vortex cylinder having an inlet and an outlet, the inlet in flow communication with the pressurized air source, and the outlet in flow communication with the inlet of the at least one air flow coil;
a second cooling vortex cylinder having an inlet and an outlet, the inlet in flow communication with the pressurized air source, and the outlet in flow communication with the inlet of the pressurized container; and
a coating application spray device having an air inlet port, a fluid inlet port, and a discharge nozzle, the air inlet port in flow communication with the outlet of the second cooling vortex cylinder, the fluid inlet port in flow communication with the pressurized container outlet, the coating application spray device entraining a flow of fluid into a flow of pressurized air to be discharged from the discharge nozzle;
wherein a flow of pressurized air through the first cooling vortex cylinder reduces the temperature of the air flow through the at least one air flow coil, thereby reducing the temperature of the container wall of the pressurized container, thereby reducing the temperature of a quantity of liquid surface coating material contained within the pressurized container, and
wherein a flow of pressurized air through the second cooling vortex cylinder reduces the temperature of the air flow to the air inlet port of the coating application spray device, thereby reducing the temperature of the pressurized air to be entrained with the fluid flow of liquid surface coating material.

3. A method for producing a temperature regulated fluid stream of surface coating material entrained in pressurized air, the fluid stream to be applied to a surface to be coated, the method comprising:
providing a source of pressurized air at a first temperature;
conducting a flow of pressurized air from the pressurized air source through a cooling vortex cylinder, the cooling vortex cylinder providing an outlet flow of cooled pressurized air at a second temperature;
providing a pressurized container with a quantity of liquid surface coating material;
conducting a flow of pressurized air into the pressurized container, the flow of pressurized air displacing and directing a portion of the quantity of liquid surface coating material out from the pressurized container;
providing at least one air flow coil in thermal contact with the pressurized container;
conducting the outlet flow of cooled pressurized air from the cooling vortex cylinder through the at least one air flow coil, the flow of cooled pressurized air cooling the quantity of liquid surface coating material within the pressurized container;
providing a coating application spray device in flow communication with the source of pressurized air and the pressurized container;
conducting a flow of a portion of the cooled quantity of liquid surface coating material out from the pressurized container to the coating application spray device;
conducting a flow of pressurized air from the pressurized air source to the coating application spray device;
entraining the flow of a portion of the cooled quantity of liquid surface coating material into the flow of pressurized air; and
discharging the entrained flow from the coating application spray device onto the surface to be coated.
